(19) United States
(12) Patent Application Publication
(10) Pub. No.: US 2013/0338271 A1
(43) Pub. Date: Dec. 19, 2013

(54) DEGRADABLE MATERIALS

(71) Applicants: Michael D. Crandall, North Oaks, MN (US); Rudolf J. Dams, Antwerp (BE); Michelle M. Hewitt, Inver Grove Heights, MN (US); Ignatius A. Kadoma, Cottage Grove, MN (US); Siegmund Papp, Woodbury, MN (US); Yong K. Wu, Woodbury, MN (US); Jay M. Jennen, Forest Lake, MN (US); Sasha B. Myers, Arden Hills, MN (US)

(72) Inventors: Michael D. Crandall, North Oaks, MN (US); Rudolf J. Dams, Antwerp (BE); Michelle M. Hewitt, Inver Grove Heights, MN (US); Ignatius A. Kadoma, Cottage Grove, MN (US); Siegmund Papp, Woodbury, MN (US); Yong K. Wu, Woodbury, MN (US); Jay M. Jennen, Forest Lake, MN (US); Sasha B. Myers, Arden Hills, MN (US)

(73) Assignee: 3M Innovative Properties Company, Saint Paul, MN (US)

(21) Appl. No.: 13/994,331

(22) PCT Filed: Dec. 8, 2011
(86) PCT No.: PCT/US11/63924

§ 371 Date: Jun. 14, 2013

Related U.S. Application Data
(60) Provisional application No. 61/423,266, filed on Dec. 15, 2010.

(51) Int. Cl. C08L 67/04

(52) U.S. Cl. CPC C08L 67/04
USPC 524/51; 525/450; 524/377; 524/47; 524/58

(57) ABSTRACT

The present disclosure relates to a degradable material comprising (a) from about 60 weight percent to about 97 weight percent of a first material based on the total weight of the degradable material, and (b) from about 3 weight percent to about 40 weight percent of a second material based on the total weight of the degradable material, where the second material is an oligomer comprising lactate and giycolate. In another aspect, the present disclosure provides a degradable material comprising (a) poly lactic acid, and (b) an oligomer comprising lactate and giycolate, wherein the degradable material has a Tg less than 56° C. In still another aspect, the present disclosure provides a degradable material comprising (a) poly lactic acid, and (b) an oligomer comprising lactate and giycolate, wherein the degradable material has a tan delta peak of less than 65° C. It has been surprisingly found that the degradable materials according to the present disclosure provide physical properties that are not inherent to poly lactic acid alone. It has also been surprisingly found that the degradable materials disclosed herein provide improvements with respect to the processability, production costs, flexibility and ductility without decreasing their degradability.

The present disclosure relates to degradable materials.

### BACKGROUND

Degradable materials have been used in various applications because of their ability to degrade and/or produce desirable degradation products. One such application is use of degradable materials as packaging materials and other disposable materials that provide for the sale and/or consumption of ingestible materials. Such disposable materials are desirable to consumers and retailers because they may be simply disposed of after use and do not have to be washed and cleaned like serving dishes, utensils and the like. Unfortunately, the widespread and growing use of such packing and disposable materials contributes to an ever increasing amount of litter and refuse that needs to be handled. This litter or refuse is either provided to garbage incinerators or accumulates in refuse dumps. These methods of waste disposal cause many problems for the environment.

Poly(lactic acid) (“PLA”) has been used as a degradable material because it decomposes in most environments. However, PLA on its own does not degrade quickly under ambient conditions. Rather, PLA can be degraded through careful controlled composting processes. It is hydrolytically degradable, however, only at elevated temperatures, e.g. above 80° C. to significant amount. For this reason, PLA is not classified to be placed into refuse dumps or landfills, in which the conditions are anaerobic for biodegradation, and temperatures are not high enough for hydrolytic degradation.

There exists a need for a relatively low-cost degradable material for which it is possible to effect degradation under various conditions.

### SUMMARY

In one aspect, the present disclosure provides a degradable material comprising (a) from about 60 weight percent to about 97 weight percent of a first material based on the total weight of the degradable material, and (b) from about 3 weight percent to about 40 weight percent of a second material based on the total weight of the degradable material, where the second material is an oligomer comprising lactate and glycolate.

In another aspect, the present disclosure provides a degradable material comprising (a) poly lactic acid, and (b) an oligomer comprising lactate and glycolate, wherein the degradable material has a Tg less than 56° C.

In still another aspect, the present disclosure provides a degradable material comprising (a) poly lactic acid, and (b) an oligomer comprising lactate and glycolate, wherein the degradable material has a tan delta peak of less than 65° C.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term:

“a”, “an”, and “the” are used interchangeably and mean one or more; and “and/or” is used to indicate one or both stated cases may occur, for example A and/or B includes,

(A and B) and (A or B). Also herein, recitation of ranges by endpoints includes all numbers subsumed within that range (e.g., 1 to 10 includes 1.4, 1.9, 2.33, 5.75, 9.98, etc.). Also herein, recitation of “at least one” includes all numbers of one and greater (e.g., at least 2, at least 4, at least 6, at least 8, at least 10, at least 25, at least 50, at least 100, etc.).

“Degradable material” means any type of degradable material other than fibers or particulates.

“Crystalline” as used in combination with polymers herein means polymers having a distinct melting point.

“Amorphous” as used in combination with polymers herein means non crystalline in that non crystalline compounds do not have a melting point, or at least no distinct melting point.

“Oligomer” means any compound having at least 4 repeating units of the same or different structure or chemical composition but having no more than 500 repeating units of the same or different structure or chemical composition.

“Polymer” means any compound having at least 1000 repeating units of the same or different structure or chemical composition.

“Copolymer” means a polymer that is derived from two or more monomeric species, including for example terpolymers, tetramers, and the like.

It has been surprisingly found that the degradable materials according to the present disclosure provide physical properties that are not inherent to poly lactic acid alone. It has also been surprisingly found that the degradable materials disclosed herein provide improvements with respect to the processability, production costs, flexibility and ductility without decreasing their degradability.

The first material useful in the present disclosure is poly lactic acid. Degradation rates of polymers are at least partially dependent upon the polymer backbone structure. For example, polymers may degrade at different rates depending on the type of repetitive unit, composition, sequence, length, molecular geometry, molecular weight, morphology (e.g., crystallinity, size of spherulites, and orientation), hydrophilicity, hydrophobicity, surface area, and additives. With regard to lactide monomer, it should be noted that lactide exists in three different forms: stereoisomers L-lactide and D-lactide and racemic D,L-lactide (meso-lactide). The chirality of lactide units provides a means to adjust, among other things, degradation rates, as well as physical and mechanical properties. Poly-L-lactide (PLLA) is the product resulting from polymerization of L-lactide. PLLA is a semi-crystalline polymer having a crystallinity of around 37%, a glass transition temperature between 50-80° C. and a melting temperature between 173-178° C. PLLA has a relatively slow degradation rate. Polymerization of a racemic mixture of L- and D-lactides typically leads to synthesis of poly-DL-lactide (PDLLA), which is an amorphous polymer, and as such, has degradation rate that is faster than that of PLLA. Use of stereospecific catalysts can lead to heterotactic PLA which has been found to show crystallinity.

The degree of crystallinity, and hence the resulting chemical and physical properties of the polymer, is controlled by the ratio of D to L enantiomers used. The stereoisomers of lactic acid may be used individually or combined in accordance with the present disclosure. Additionally, the lactic acid stereoisomers can be modified by blending high and low molecular weight poly(lactide). Commercially available examples of poly lactic acids useful in the present disclosure include, for example, an amorphous poly lactic acid commercially available under the trade designation “PLA 4060” and a crystalline poly lactic acid commercially available under the trade designation “PLA 4032” both from NatureWorks, Minnetonka, Minn.

The second material used in the present disclosure is an oligomer including lactate and glycolate repeating units. The terms “lactate” and “lactic acid” are used interchangeably herein. The terms “glycolate” and “glycolic acid” are used interchangeably herein. In some embodiments, the weight percent of lactate based on the total weight of the monomers is greater than or equal to about 25 weight percent. In some embodiments, the weight percent of lactate based on the total weight of the monomers is greater than or equal to about 30 weight percent. In some embodiments, the weight percent of lactate based on the total weight of the monomers is greater than or equal to about 35 weight percent. In some embodiments, the weight percent of lactate based on the total weight of the monomers is greater than or equal to about 40 weight percent. In some embodiments, the weight percent of lactate based on the total weight of the monomers is greater than or equal to about 45 weight percent. In some embodiments, the weight percent of lactate based on the total weight of the monomers is greater than or equal to about 50 weight percent. In some embodiments, the weight percent of lactate based on the total weight of the monomers is greater than or equal to about 55 weight percent. In some embodiments, the weight percent of lactate based on the total weight of the monomers is greater than or equal to about 60 weight percent. In some embodiments, the weight percent of lactate based on the total weight of the monomers is greater than or equal to about 65 weight percent. In some embodiments, the weight percent of lactate based on the total weight of the monomers is greater than or equal to about 70 weight percent.

In some embodiments, the weight percent of lactate based on the total weight of the monomers is less than or equal to about 75 weight percent. In some embodiments, the weight percent of lactate based on the total weight of the monomers is less than or equal to about 70 weight percent. In some embodiments, the weight percent of lactate based on the total weight of the monomers is less than or equal to about 65 weight percent. In some embodiments, the weight percent of lactate based on the total weight of the monomers is less than or equal to about 60 weight percent. In some embodiments, the weight percent of lactate based on the total weight of the monomers is less than or equal to about 55 weight percent. In some embodiments, the weight percent of lactate based on the total weight of the monomers is less than or equal to about 50 weight percent. In some embodiments, the weight percent of lactate based on the total weight of the monomers is less than or equal to about 45 weight percent. In some embodiments, the weight percent of lactate based on the total weight of the monomers is less than or equal to about 40 weight percent. In some embodiments, the weight percent of lactate based on the total weight of the monomers is less than or equal to about 35 weight percent. In some embodiments, the weight percent of lactate based on the total weight of the monomers is less than or equal to about 30 weight percent. In some embodiments, the weight percent of lactate based on the total weight of the monomers ranges from about 25 to about 75 weight percent.

In some embodiments, the weight percent of glycolate based on the total weight of the monomers is greater than or equal to about 25 weight percent. In some embodiments, the weight percent of glycolate based on the total weight of the monomers is greater than or equal to about 30 weight percent. In some embodiments, the weight percent of glycolate based on the total weight of the monomers is greater than or equal to about 35 weight percent. In some embodiments, the weight percent of glycolate based on the total weight of the monomers is greater than or equal to about 40 weight percent. In some embodiments, the weight percent of glycolate based on the total weight of the monomers is greater than or equal to about 45 weight percent. In some embodiments, the weight percent of glycolate based on the total weight of the monomers is greater than or equal to about 50 weight percent. In some embodiments, the weight percent of glycolate based on the total weight of the monomers is greater than or equal to about 55 weight percent. In some embodiments, the weight percent of glycolate based on the total weight of the monomers is greater than or equal to about 60 weight percent. In some embodiments, the weight percent of glycolate based on the total weight of the monomers is greater than or equal to about 65 weight percent. In some embodiments, the weight percent of glycolate based on the total weight of the monomers is greater than or equal to about 70 weight percent.

In some embodiments, the weight percent of glycolate based on the total weight of the monomers is less than or equal to about 75 weight percent. In some embodiments, the weight percent of glycolate based on the total weight of the monomers is less than or equal to about 70 weight percent. In some embodiments, the weight percent of glycolate based on the total weight of the monomers is less than or equal to about 65 weight percent. In some embodiments, the weight percent of glycolate based on the total weight of the monomers is less than or equal to about 60 weight percent. In some embodiments, the weight percent of glycolate based on the total weight of the monomers is less than or equal to about 55 weight percent. In some embodiments, the weight percent of glycolate based on the total weight of the monomers is less than or equal to about 50 weight percent. In some embodiments, the weight percent of glycolate based on the total weight of the monomers is less than or equal to about 45 weight percent. In some embodiments, the weight percent of glycolate based on the total weight of the monomers is less than or equal to about 40 weight percent. In some embodiments, the weight percent of glycolate based on the total weight of the monomers is less than or equal to about 35 weight percent. In some embodiments, the weight percent of glycolate based on the total weight of the monomers is less than or equal to about 30 weight percent. In some embodiments, the weight percent of glycolate based on the total weight of the monomers ranges from about 25 to about 75 weight percent.

The second material may also include one or more additional components. These components include, but are not limited to, derivatives of oligomeric lactic acid, polyethylene glycol; polyethylene oxide; oligomeric lactic acid; citrate esters (such as tributyl citrate oligomers, triethyl citrate, acetyltributyl citrate, acetyltriethyl citrate); glucose monoesters; partially fatty acid esters; PEG monolaurate; triacetin; poly([epsilon]-caprolactone); poly(hydroxybutyrate); glycerin-1-benzoate-2,3-dilaurate; glycerin-2-benzoate-1,3-dilaurate; starch; bis(butyl diethylene glycol)adipate; ethylphthalylethyl glycolate; glycerine diacetate monocaprylate; diacetyl monoacyl glycerol; polypropylene glycol (and epoxy, derivatives thereof); polypropylene glycol)dibenzoate, dipropylene glycol dibenzoate; glycerol; ethyl phthalyl ethyl glycolate; poly(ethylene adipate)distearate; di-iso-butyl adipate; and combinations thereof.

Degradable materials according to the present disclosure may degrade both chemically and physically. Without wishing to be bound by theory, it is believed that the second material behaves as a degradation additive and initiates the degradation process by catalyzing the hydrolysis of the first material (e.g., poly lactic acid). Such as, for example, an oligomer of lactic and glycolic acids will degrade rapidly forming acidic compounds in-situ, respectively a mixture of glycolic acid and lactic acid.

The first and second materials can be processed like most thermoplastics into films and other types of materials. The first and second material are to be combined, such as for example in pellet form, in various weight ratios or weight percents. In some embodiments, the first material is present in a major amount. In some embodiments the weight percent of the first material based on the total weight of the degradable material is greater than 50 weight percent, greater than 60 weight percent, greater than 70 weight percent, greater than 80 weight percent, greater than 90 weight percent, or even greater than 95 weight percent. In some embodiments, the weight percent of the first material based on the total weight of the degradable material is greater than 50 weight percent and less than 99 weight percent. In some embodiments, the weight percent of the first material based on the total weight of the degradable material is between about 60 weight percent and about 97 weight percent.

In some embodiments, the second material is present in a minor amount. In some embodiments the weight percent of the second material based on the total weight of the degradable material is less than 50 weight percent, less than 40 weight percent, less than 30 weight percent, less than 20 weight percent, less than 10 weight percent, or even less than 5 weight percent. In some embodiments, the weight percent of the second material based on the total weight of the degradable material is less than 50 weight percent and greater than 1 weight percent. In some embodiments, the weight percent of the second material based on the total weight of the degradable material is between about 4 weight percent and about 30 weight percent.

In an embodiment, the degradable materials can be made by mixing or blending the first and second materials in the desired amounts. This may be performed according to any method known by the skilled artisan. For example, poly lactic acid polymer and oligomer including lactate and glycolate repeating units may be mixed in pure form, for example blended by means of mill roll blending, and heated to a temperature chosen according to the general knowledge in the art such that at least one of the above-mentioned components is partially or essentially completely molten. In some embodiments, the first and/or second materials are dried before being mixed together. For example, in some embodiments, the first material is dried overnight at a drying temperature, such as 41° C.

In one embodiment, the first material and second material are combined in an extruder, such as for example a 25 mm twin screw extruder (commercially available under the trade designation “Ultraglide” from Berstorff, Hannover, Germany). The extruder is then heated depending on the type of materials selected for use as the first and second material. For example, in some embodiments the extruder is heated to temperatures ranging from about 190° C. to about 230° C. In some embodiments, the extruder is heated to about 150° C. Pellets of the degradable material are then prepared by drawing molten strands of the degradable material through a cooling medium, such as cold water, and cutting the cooled strands into pellets. In some embodiments, the pellets of degradable material have a cylindrical shape. The pellets are then dried. For example, in some embodiments, the pellets are dried overnight under vacuum of about 40 to 50 mmHg at 41° C. In some embodiments, an underwater pelletizer is attached directly to the outlet of the extruder.

The presently disclosed degradable materials may be used for the production of various articles, such as, for example, extruded articles. The term “extruded article” as used herein includes articles made according to an extrusion process. An extruded article can be part of another object. Exemplary extruded articles are films, trash bags, grocery bags, container sealing films, pipes, drinking straws, spun-bonded non-woven materials, and sheets. Articles according to the present disclosure can be made from a profile extrusion formulation (e.g. drinking straws and pipes). Articles according to the present disclosure can also made from a thermoform extrusion method (e.g. sheets for producing cups, plates and other objects that could be outside of the food service industry).

In some embodiments, such extruded articles are made by feeding pellets of the degradable material into the single screw extruder such as the one commercially available under the trade designation “Intelli-Torque model” from C. W. Brabender, South

Hackensack, N.J., which has 3 temperature zones. Dies of different sizes and shapes can be used depending on the desired application and physical characteristics of the resulting extruded article. For example, in some embodiments, a 6 inch (15.24 cm) flat sheet film die (commercially available under the trade designation “Ultraflex-40” from Extrusion Die Inc. Chippewa Falls, Wis.) can be used. The extruder is then heated depending on the type of materials selected for use as the first and second material and the type of extruded article being made. For example, in some embodiments the extruder is heated to a temperature of about 149° C. Various die gaps can be set on the extruded depending on the desired thickness of the resulting extruded article. In an exemplary embodiment, a 0.127 mm die gap was set and an extruded article in the form of a film having a thickness of 0.025 mm was cast. Rotation speed and torque settings on the extruded can also be altered depending on the type of extruded article being made. For example, a rotation speed of the single screw extruder can be 90 rpm and a torque can be 46%.

### Additives

Modifiers and other additives can be added to the degradable material disclosed herein. For example, plasticizers can be added to the presently disclosed degradable material.

Plasticizers are materials which alter the physical properties of the polymer to which they are added, such as, for example, modifying the glass transition temperature of the polymer. Typically the plasticizer(s) need to be compatible with the polymer to make the effect noticeable. In some embodiments, plasticizers useful in the present disclosure include polyethylene oxide; citrate esters; triethyl citrate; acetyltributyl citrate;

acetyltriethyl citrate; glucose monoesters; partially fatty acid esters; PEG monolaurate; triacetin; poly([epsilon]-caprolactone); poly(hydroxybutyrate); glycerin-1-benzoate-2,3-dilaurate; glycerin-2-benzoate-1,3-dilaurate; bis(butyl diethylene glycol)adipate; glycerine diacetate monocaprylate; diacetyl monoacyl glycerol; polypropylene glycol)dibenzoate, dipropylene glycol dibenzoate; glycerol; ethyl phthalyl ethyl glycolate; poly(ethylene adipate)distearate; di-iso-butyl adipate; diethyl phthalate; p-toluene ethyl sulfonamide; triphenyl phosphate; triethyl tricarballylate; methyl phthallyl ethyl glycolate; sucrose octaacetate; sorbitol hexaacetate; mannitol hexaacetate; pentaerythritol tetraacetate; triethylene diacetate; diethylene dipropionate; diethylene diacetate; tributyrin; tripropionin; and the like; and combinations thereof.

In some embodiments, plasticizer useful in the present disclosure include “in natura” (as found in nature) vegetable oil or its ester or epoxy derivative coming from soybean, corn, castor-oil, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, and the like. Also synthetic materials derived from hydrocarbons such as oil or natural gas are also suitable. Examples of these materials include phthalates such as 2-ethyl hexyl phthalate, adipates such as dioctyl adipate, trimellitates such as trimethyl trimellitate, and maleates such as dioctyl maleate.

Natural fillers may also be added to the presently disclosed degradable material. Natural fillers useful in the present disclosure include lignocellulosic fillers, such as, for example, wood flour or wood dust, starches and rice husk, and the like. Other useful fillers include talc and calcium carbonate. Processing aid/dispersant can be used in the presently disclosed degradable material. Exemplary, processing aid/dispersants useful in the present disclosure include compositions with thermoplastics, such as that available under the trade designation “Struktol” (commercially available from Struktol Company of America.

Nucleants, such as, for example boron nitride or a nucleant available under the trade designation “HPN” (commercially available from Milliken) are another type of additive that can be added to the presently disclosed degradable material. Compatibilizers are another category of additives that can be used in the present disclosure. Exemplary compatibilizers include polyolefine functionalized or grafted with anhydride maleic; ionomer based on copolymer ethylene-acrylic acid or ethylene-methacrylic acid neutralized with sodium (such as those available under the trade designation “Surlyn” from DuPont). Other additives useful in the present disclosure include thermal stabilizers, such as, for example, primary antioxidant and secondary antioxidant, pigments; ultraviolet stabilizers of the oligomeric HALS type (hindered amine light stabilizer).

Following are exemplary embodiments of the present disclosure:

### Embodiment 1

A degradable material comprising:

(a) from about 60 weight percent to about 97 weight percent of a first material based on the total weight of the degradable material, and (b) from about 3 weight percent to about 40 weight percent of a second material based on the total weight of the degradable material,

wherein the second material is an oligomer comprising lactate and glycolate.

### Embodiment 2

The degradable material of embodiment 1 wherein the first material is poly lactic acid.

### Embodiment 3

The degradable material of any of the preceding embodiment further comprising:

(c) a plasticizer.

### Embodiment 4

The degradable material of embodiment 3 wherein the plasticizer is selected from polyethylene glycol, starch, glucose, polypropylene glycol, and ethers and esters thereof and combinations thereof.

### Embodiment 5

The degradable material of any preceding embodiment wherein the second material comprises 25 to 75 weight percent of lactate and 25 to 75 weight percent of glycolate, wherein the weight percent is based on the total weight of the second material.

### Embodiment 6

The degradable material of any preceding embodiment wherein the first material is amorphous.

### Embodiment 7

The degradable material of embodiment 1, 2, 3, 4 or 5 wherein the first material is crystalline.

### Embodiment 8

The degradable material of embodiment 1, 2, 3, 4 or 5 wherein the first material is a mixture of crystalline and amorphous.

### Embodiment 9

The degradable material of embodiment 6 wherein the material has a degradation level of at least 3 weight percent based on the total weight of the degradable material when subjected to a temperature of about 38° C. for seven days in the presence of moisture.

### Embodiment 10

The degradable material of embodiment 7 wherein the material has a degradation level of at least 5 weight percent based on the total weight of the degradable material when subjected to a temperature of about 38° C. for seven days in the presence of moisture.

### Embodiment 11

The degradable material of embodiment 8 wherein the material has a degradation level of at least 7 weight percent based on the total weight of the degradable material when subjected to a temperature of about 38° C. for seven days in the presence of moisture.

### Embodiment 12

A degradable material comprising:
(a) poly lactic acid, and
(b) an oligomer comprising lactate and glycolate,
   wherein the degradable material has a Tg less than 56° C.

### Embodiment 13

The degradable material of embodiment 12 further comprising:
(c) a plasticizer.

### Embodiment 14

The degradable material of embodiment 13 wherein the plasticizer is selected from polyethylene glycol, starch, glucose, polypropylene glycol, and ethers and esters thereof and combinations thereof.

### Embodiment 15

The degradable material of embodiment 12, 13 or 14 wherein the second material comprises 25 to 75 weight percent of lactate and 25 to 75 weight percent of glycolate, wherein the weight percent is based on the total weight of the second material.

### Embodiment 16

The degradable material of embodiment 12, 13, 14 or 15 wherein the first material is amorphous.

### Embodiment 17

The degradable material of embodiment 12, 13, 14 or 15 wherein the first material is crystalline.

### Embodiment 18

The degradable material of embodiment 12, 13, 14 or 15 wherein the first material is a mixture of crystalline and amorphous.

### Embodiment 19

The degradable material of embodiment 16 wherein the material has a degradation level of at least 3 weight percent based on the total weight of the degradable material when subjected to a temperature of about 38° C. for seven days in the presence of moisture.

### Embodiment 20

The degradable material of embodiment 17 wherein the material has a degradation level of at least 5 weight percent based on the total weight of the degradable material when subjected to a temperature of about 38° C. for seven days in the presence of moisture.

### Embodiment 21

The degradable material of embodiment 18 wherein the material has a degradation level of at least 7 weight percent based on the total weight of the degradable material when subjected to a temperature of about 38° C. for seven days in the presence of moisture.

### Embodiment 22

A degradable material comprising:
(a) poly lactic acid, and
(b) an oligomer comprising lactate and glycolate,
   wherein the degradable material has a tan delta peak of less than 65° C.

### Embodiment 23

The degradable material of any of embodiment 22 further comprising:
(c) a plasticizer.

### Embodiment 24

The degradable material of embodiment 23 wherein the plasticizer is selected from polyethylene glycol, starch, glucose, polypropylene glycol, and ethers and esters thereof and combinations thereof.

### Embodiment 25

The degradable material of embodiment 22, 23 or 24 wherein the second material comprises 25 to 75 weight percent of lactate and 25 to 75 weight percent of glycolate, wherein the weight percent is based on the total weight of the second material.

### Embodiment 26

The degradable material of embodiment 22, 23, 24 or 25 wherein the first material is amorphous.

### Embodiment 27

The degradable material of embodiment 22, 23, 24 or 25 wherein the first material is crystalline.

### Embodiment 28

The degradable material of embodiment 22, 23, 24 or 25 wherein the first material is a mixture of crystalline and amorphous.

### Embodiment 29

The degradable material of embodiment 26 wherein the material has a degradation level of at least 3 weight percent based on the total weight of the degradable material when subjected to a temperature of about 38° C. for seven days in the presence of moisture.

### Embodiment 30

The degradable material of embodiment 27 wherein the material has a degradation level of at least 5 weight percent based on the total weight of the degradable material when subjected to a temperature of about 38° C. for seven days in the presence of moisture.

### Embodiment 31

The degradable material of embodiment 28 wherein the material has a degradation level of at least 7 weight percent based on the total weight of the degradable material when subjected to a temperature of about 38° C. for seven days in the presence of moisture.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

These abbreviations are used in the following examples: g=gram, min=minutes, cm=centimeter, mm=millimeter, ml=milliliter, Pa=Pascal, and mmHg=millimeters of mercury.

In the following examples, indicated results were obtained using the following test methods:

### Dynamic Mechanical Analysis (DMA):

DMA was conducted using a DMS6100 model EXSTAR 6000 from Seiko Instruments, Austin, Tex. Each test sample was prepared from a thin film of approximately 40 microns in thickness. Using a punch die, samples measuring 12 mm by 20 mm were punched out from this film. At the beginning of the experiment, the test sample was secured between two oscillating clamps of the DMS6100 and enclosed in a well sealed environmental chamber comprising a liquid nitrogen dewar that was used to control the temperature during the experiment. While in the chamber, the sample was simultaneously subjected to an oscillating tensile force of 10 grammeforce at a frequency of 1 Hertz and a temperature sweep from −30° C. to 130° C. The temperature sweep was run at a rate of 3° C./min. Tensile Elastic modulus at 55° C. and tan Delta peak were measured for each sample.

Glass-transition temperatures (Tg) and heat of melting peak for the crystalline PLA blends:

Tg and heat of melting peak (ΔH_{crystalline}) were measured with a Modulated Differential Scanning calorimetry (MDSC), Model Q2000 DSC Instrument from TA Instruments, New Castle, Del. Each test sample was prepared from a thin film of approximately 40 microns in thickness. Using a punch die, circular samples of 4.8 mm diameter were cut out and crimped into Aluminum DSC pans. Modulated DSC (MDSC) was run with a 3° C. per minute heating rate, approximately 1.0° C. temperature modulation, 60 second modulation period, and heat from 0° C. to 300° C. Thermal analysis software was used to generate plots of Heat Flow versus temperature and glass-transition temperature (Tg) values.

The following materials were used in the following Examples:

### First Material:

“PLA 4060”: amorphous polylactic acid commercially available from NatureWorks, Minnetonka, Minn.

“PLA 4032”: crystalline polylactic acid commercially available from Nature Works.

### Second Material:

Oligomeric copolymer of 75 mole percent lactic acid and 25 mole percent glycolic acid (OLGA) prepared according to the following description: approximately 106.2 g of an aqueous solution of lactic acid (commercially available from ADM, Decatur, Ill.) and 37.6 g of glycolic acid (commercially available from DuPont, Wilmington, Del.) were added to a 250 ml reactor. Approximately 24 g of water was distilled off at a temperature of 55° C. and vacuum of 50 mmHg. After, the batch temperature was risen to 125° C. and the reaction was kept under these conditions 4 hours. Nitrogen was purged into the mixture and a sample was drawn out for titration with 0.5 N Potassium Hydroxide (KOH) in methanol. When a titration value of 350 g/equivalent was reached, the reaction was stopped and the OLGA material was removed from the reactor.

### Comparative Example A:

A non-degrading film was prepared using a single screw extruder (commercially available under the trade designation “Intelli-Torque model” from C. W. Brabender, South Hackensack, N.J.) having 3 temperature zones. A 6 in (15.24 cm) flat sheet film die (commercially available under the trade designation “Ultraflex-40” from Extrusion Die Inc. Chippewa Falls, Wis.) was mounted on the extruder. Pellets of PLA 4060 previously dried overnight at a drying temperature of 41° C. (105° F.) under vacuum (from about 100 -500 mmHg (13.32 Pa-66.7 Pa)) were fed into the single screw extruder, with the die and extruder heated to about 149° C. (300° F.). A 0.127 mm (5 mil) die gap was set and a film having a thickness of 0.025 mm (1 mil) was cast. The rotation speed of the single screw extruder was 90 rpm and the torque was 46%.

### Comparative Example B:

A non-degrading film was prepared as described in Comparative Example 1, except that PLA 4032 was used instead of PLA 4060. Pellets of PLA 4032 were dried overnight at 77° C. (170° F.) prior to being fed into the single screw extruder.

Table 1 below, summarizes the process conditions for Comparative Examples 1 and 2.

TABLE 1
Process conditions for Comparative Examples A and B.

| | | | Temperature (° C.) | | | | |
|---|---|---|---|---|---|---|---|
| | Extruder | Extruder | Zone | Zone | Zone | | |
| Example | (rpm) | torque (%) | 1 | 2 | 3 | Adapter | Die |
| Comparative | 90 | 46 | 165 | 171 | 182 | 193 | 193 |
| Example A | | | | | | | |
| Comparative | 90 | 45 | 196 | 204 | 204 | 204 | 204 |
| Example B | | | | | | | |

### Example 1

A degradable master batch was prepared by blending first and second materials. Pellets of PLA 4060 and OLGA were mixed in a 25 mm twin screw extruder (commercially available under the trade designation “Ultraglide” from Berstorff, Hannover, Germany) at an 80/20 weight ratio. Prior to blending the first and second materials, the PLA 4060 was dried overnight at a drying temperature of 41° C. (105° F.) under vacuum (100 -500 mmHg (13.3 Pa-66.7 Pa)). The twin screw extruder was heated to about 150° C. and the molten strand of material was drawn through cold water and cut into cylindrical pellets. The pellets were dried overnight under vacuum 13.3 to 66.7 Pa at 41° C.

A degradable film was cast by feeding pellets of the degradable master batch into the single screw extruder, as described in Comparative Example 1, except that the extruder torque was 36%.

TABLE 2
Composition and process conditions for Example 1.

| | | | Temperature (° C.) | | | | |
|---|---|---|---|---|---|---|---|
| | Extruder | Extruder | Zone | Zone | Zone | | Zone |
| Example | (rpm) | torque (%) | 1 | 2 | 3 | Adapter | 1 |
| Example 1 | 90 | 36 | 138 | 143 | 149 | 149 | 149 |

### Examples 2-4

The following description was used in Examples 2 through 4: A degradable master batch was prepared by blending first and second materials as described in Example 1. Degradable films were then prepared by mixing pellets of the degradable master batch with pellets of PLA 4060 in the single screw extruder, as described in Comparative Example 1. Table 3, below shows composition and process conditions for Examples 2-4.

TABLE 3
Composition and process conditions for Examples 2-4.

| | Weight ratio | | Extruder | | | | | |
|---|---|---|---|---|---|---|---|---|
| | Masterbatch/ | Extruder | torque | Temperature (° C.) | | | | |
| Examples | PLA 4060 | (rpm) | (%) | Zone 1 | Zone 2 | Zone 3 | Adapter | Zone 1 |
| Example 2 | 75/25 | 90 | 31 | 149 | 154 | 160 | 165 | 165 |
| Example 3 | 50/50 | 90 | 33 | 154 | 160 | 165 | 177 | 177 |
| Example 4 | 25/75 | 90 | 40 | 160 | 165 | 171 | 185 | 185 |

### Examples 5-8

The following description was used in Examples 5 through 8: A degradable master batch was prepared by blending first and second materials as described in Example 1, except that PLA 4032 was used as the first material. PLA 4032 was dried overnight at 77° C. (170° F.) prior to compounding it with the second material (OLGA). Pellets of the degradable master batch were dried overnight under vacuum at 77° C. Degradable films were then prepared by mixing pellets of the master batch with pellets of PLA 4032 into the single screw extruder, as described in Comparative Example 1. Table 4, below shows composition and process conditions for Examples 5-8.

TABLE 4
Composition and process conditions for Examples 5-8.

| | Weight ratio | | Extruder | | | | | |
|---|---|---|---|---|---|---|---|---|
| | Masterbatch/ | Extruder | torque | Temperature (° C.) | | | | |
| Examples | PLA 4032 | (rpm) | (%) | Zone 1 | Zone 2 | Zone 3 | Adapter | Zone 1 |
| Example 5 | 25/75 | 90 | 37 | 188 | 193 | 196 | 199 | 199 |
| Example 6 | 50/50 | 90 | 40 | 171 | 177 | 182 | 182 | 182 |
| Example 7 | 75/25 | 90 | 37 | 154 | 160 | 165 | 165 | 165 |
| Example 8 | 100/0 | 90 | 33 | 154 | 160 | 165 | 165 | 165 |

A summary of Comparative Examples A and B, and Examples 1-8 based on the total amount of first and second materials is in Table 5, below.

TABLE 5
Summary of Comparative Examples A and B and Examples 1-8.

| | | PLA/OLGA |
|---|---|---|
| Examples | PLA | weight ratio |
| Comparative Example A | PLA 4060 | 100 |
| Comparative Example B | PLA 4032 | 100 |
| Example 1 | PLA 4060 | 80/20 |
| Example 2 | PLA 4060 | 85/15 |
| Example 3 | PLA 4060 | 90/10 |
| Example 4 | PLA 4060 | 95/5 |
| Example 5 | PLA 4032 | 95/5 |
| Example 6 | PLA 4032 | 90/10 |
| Example 7 | PLA 4032 | 85/15 |
| Example 8 | PLA 4032 | 80/20 |

Samples of non-degrading films prepared as described in Comparative Examples A and B, and samples of degradable films prepared as described in Examples 1-8 were submitted to DMA testing, Tg and heat of melting (ΔH_{crystalline}) measurement for the crystalline blends, as described above. Results for tensile elastic modulus at 55° C., tan delta peak, Tg and heat of melting are reported in Table 6, below.

TABLE 6
Tensile elastic modulus, tan delta peak, Tg and heat of melting for
Comparative Examples A and B, and Examples 1-8.

| | Tensile elastic | | | |
|---|---|---|---|---|
| | modulus at | Tan Delta | Tg | ΔH_{Crystalline} |
| Examples | 55° C. (Pa) | Peak (° C.) | (° C.) | (J/g) |
| Comp. Example A | 2.92E+09 | 66 | 58.2 | — |
| Comp. Example B | 2.34E+08 | 70 | 60.5 | 39.4 |
| Example 1 | 2.10E+06 | 43 | 39.0 | — |
| Example 2 | 1.38E+05 | 52 | 43.8 | — |
| Example 3 | 1.04E+05 | 56 | 47.9 | — |
| Example 4 | 2.67E+09 | 60 | 50.3 | — |
| Example 5 | 6.94E+08 | 63 | 52.3 | 37.7 |
| Example 6 | 1.17E+08 | 60 | 48.9 | 38.2 |
| Example 7 | 1.26E+05 | 54 | 43.7 | 38.0 |
| Example 8 | 6.72E+04 | 51 | 38.9 | 37.6 |

Degradation rate of films prepared as described in Comparative Examples A and B, and Examples 1-8 was measured at 38° C. (100° F.) after seven days. To separate containers, a film weighing approximately 1.0 grams and 100 grams of deionized (DI) water were added. The containers were placed in a convection oven set at a testing temperature of about 38° C. for seven days. After, water was drained from the containers and the film was dried at 65° C. overnight (approximately 16 hours). The film was removed from the oven and allowed to cool at room ambient conditions before being weighed. Percent weight loss was then calculated and is reported in Table 7, below.

TABLE 7
Percent weight loss at 38° C.

| | Percent weight |
|---|---|
| Examples | loss at 38° C. (%) |
| Comparative Example A | 3.85 |
| Comparative Example B | −0.48 |
| Example 1 | 9.74 |
| Example 2 | 9.20 |
| Example 3 | 8.33 |
| Example 4 | 5.91 |
| Example 5 | 6.41 |
| Example 6 | 7.73 |
| Example 7 | 7.48 |
| Example 8 | 9.38 |

Neither PLA 4060 nor PLA 4032 alone produced degradable films with degradation level of at least 5% after seven days at 38° C. Degradation levels of the degradable films according to the present disclosure are significantly higher than that of Comparative Examples A and B.

Various modifications and alterations of this invention will become apparent to those skilled in the art without departing from the scope and spirit of this invention.

What is claimed is:

1. A degradable material comprising:
(a) from about 60 weight percent to about 97 weight percent of a first material based on the total weight of the degradable material, and
(b) from about 3 weight percent to about 40 weight percent of a second material based on the total weight of the degradable material,
wherein the second material is an oligomer comprising lactate and glycolate.

2. The degradable material of claim 1 wherein the first material is poly lactic acid.

3. The degradable material of claim 1 further comprising:
(c) a plasticizer.

4. The degradable material of claim 3 wherein the plasticizer is selected from polyethylene glycol, starch, glucose, polypropylene glycol, and ethers and esters thereof and combinations thereof.

5. The degradable material of claim 1 wherein the second material comprises 25 to 75 weight percent of lactate and 25 to 75 weight percent of glycolate, wherein the weight percent is based on the total weight of the second material.

6. The degradable material of claim 1 wherein the first material is amorphous.

7. The degradable material of claim 1 wherein the first material is crystalline.

8. The degradable material of claim 1 wherein the first material is a mixture of crystalline and amorphous.

9. The degradable material of claim 1 wherein the material has a degradation level of at least 7 weight percent based on the total weight of the degradable material when subjected to a temperature of about 38° C. for seven days in the presence of moisture.

10. A degradable material comprising:
(a) poly lactic acid, and
(b) an oligomer comprising lactate and glycolate,
wherein the degradable material has a Tg less than 56° C.

11. A degradable material comprising:
(a) poly lactic acid, and
(b) an oligomer comprising lactate and glycolate,
wherein the degradable material has a tan delta peak of less than 65° C.
